(19) United States
(12) Patent Application Publication
(10) Pub. No.: US 2006/0165885 A1
(43) Pub. Date: Jul. 27, 2006

(54) Method of insulating cavities in a structure using a spray-on method and resultant insulation

(76) Inventor: Ralph Michael Fay, Lakewood, CO (US)

Correspondence Address: JOHNS MANVILLE;Legal Department, 10100 West Ute Avenue, Littleton, CO, 80127, US

(21) Appl. No.: 11/024,212

(22) Filed: Dec. 28, 2004

(51) Int. Cl. B05D 1/16

(52) U.S. Cl. 427/206

(57) ABSTRACT

A method of applying dry or low moisture fibrous thermal insulation by spraying an air entrained stream of pieces of fibrous insulation into cavities in a structure in which at least the largest area wall of the cavity is at least partially coated with a pressure sensitive adhesive, including vertical wall cavities, without having to use any insulation securing means is disclosed. The pressure sensitive adhesive is applied to at least part of one or more walls of the cavity and allowed to form a tacky surface prior to spraying in the pieces of fibrous insulation. The resultant just installed insulation, because of its low moisture content, requires either no drying time or less drying time than conventional blown in insulation before wall board or other facing material is applied without fear of mold forming.

The present invention involves a method of insulating cavities in a structure by first spraying a tacky coating, such as a liquidous pressure sensitive adhesive, onto the walls of the cavities followed by spraying dry or nearly dry insulation into the cavities, and the resultant installed insulation product.

It is conventional to pump or blow loose fill fibrous insulation into attics, walls, etc. of houses and other buildings. It is also known to add a binder, de-dusting oil, anti-static agent and/or fungicide to small pieces of fiberglass, mineral wool or other fibrous insulation in or near a blowing nozzle to prevent settling, sparking and mold or to reduce dust in the area of the installation during installation. Such technology can be found in U.S. Pat. Nos. 4,710,4804, 4,804,695, but as stated in U.S. Pat. No. 5,952,418, the disclosures of which are incorporated herein by reference, but these systems suffer from problems of blockage of adhesive nozzles and/or a blowing hose. Further, these systems require a moisture content in the preinstalled product that is so high that the insulation requires a long drying time, two or more days, of the wall cavity installations before wall board can be installed if potential mold problems, such as in the paper facing of the wall board are to be avoided.

It is also known to spray clumps of fiber glass insulation coated with water and a non-foaming binder into wall cavities followed by rolling at least about an inch of excess insulation thickness down to the thickness of the wall studs followed by spraying additional clumps of insulation into any thin spots or unfilled cavities and apparently again rolling excess thickness down to the thickness of the studs. As disclosed in U.S. Pat. No. 5,641,368, the installed insulation is reported to have a moisture content of less than about 35 wt. percent and moisture contents of less than 10 percent are disclosed for some examples, but it is unclear how long after installation the samples were removed for testing. When using lower moisture content, the clumps do not stick well to certain conventional linings of wall cavities and the rolled insulation tends to spring back in some areas. Also, the additional step of spraying a second time slows the building installation process. Nozzles for spraying water on or an aqueous binder onto clumps of insulation while the latter are inside the nozzle are shown in U.S. Pat. Nos. 4,923,121 and 5,921,055, but these nozzles from liquid and binder striking the inside walls of the nozzle causing fiber and particles to build up on the inside of the nozzle.

With concerns of mold problems in walls of various kinds of structures reaching serious levels, and installed lowest installed costs being important to commercial success, a loose fill insulation, particularly an inorganic fiber insulation, that contains a low moisture content or substantially no moisture just after installation and that will dry more rapidly to a level suitable for installing wall board is greatly needed to reduce costs of construction and to reduce the potential for mold problems. The present invention addresses these needs.

The invention includes a method of installing spray-on fibrous thermal insulation in cavities of structures by first coating at least the critical areas, and more typically a majority of the area, of each cavity with a tacky coating such as a pressure sensitive adhesive that forms a tacky surface, and then spraying clumps, nodules or pils of fibrous insulation into the cavities. The invention also includes just-installed fibrous insulation having on at least a portion of its surface adjacent a component of a structure of the cavity, a coating or layer of a tacky substance or adhesive. By “just-installed” is meant a sprayed-in insulation product no more than 60 minutes after installation and typically no more than 30-45 minutes after installation. By critical areas is meant that area that if not coated with a tacky substance will prevent the blown-in insulation from staying in the cavity without excessive fall out and/or collapse. Excessive fall out is known in the industry.

The fibrous insulation comprises clumps, nodules, pils and mixtures thereof comprising fibers, typically having an average diameter of less than about 5 microns, more typically less than about 4 microns and most typically less than about 3 microns. The fibers are selected from a group consisting of glass fibers, other inorganic fibers, polymer fibers, natural (plant or animal) fibers and cellulosic fibers. For purposes of describing the invention glass fibers are most exemplary. Advantages of the invention are many including having to put less moisture into the insulation prior to blowing and avoiding the necessity of having to use any conventional insulation securing means, such as a retaining net or retaining sheet, when using the present invention to keep fallout below an acceptable level.

The liquidous pressure sensitive adhesive used to spray a coating, continuous or discontinuous, onto at least one wall of a cavity in a structure like a building, equipment housing, vehicle, or other structure, before spraying or blowing in the fibrous insulation, is preferably in aqueous solution, suspension or emulsion, but hydro-carbon solvents or hydrocarbon carriers can also be used. Pressure sensitive hot melt adhesives will also work well but are harder to use, particularly on normal sized residential structures due to the necessary hot melt equipment and electrical power requirements that are often cumbersome at these type of building sites. Hot melt pressure sensitive adhesives are especially useful when this invention is used in a factory setting, such as producing walls for pre-manufactured homes. In such applications hot melt pressure sensitive adhesives are advantageous since they add no water (moisture) to the building structure and is immediately ready after application of the insulation for the interior wall material to be installed.

Any pressure sensitive type adhesive can be used that leaves a tacky surface on the structural member. Acrylic resins and styrene-butadiene-rubber, having a glass transition temperature typically below about 15 degrees Celcius, more typically less than about 0 degrees with those being less than about minus 10 or even minus 20 degrees being exemplary. A benefit of using a liquidous pressure sensitive adhesive is that it can also easily contain one or more of functional ingredients such as IR barrier agents, anti-static agents, anti-fungal agents, biocides, pesticides, fillers, pigments, phase change thermal modulators, insulating microspheres, colorants, etc.

The coating of a liquid pressure sensitive adhesive or adhesive mixture on at least one wall of the cavity causes the initial pieces of insulation entering the cavity to adhere to the coating of pressure sensitive adhesive providing a layer of insulation for subsequent pieces of insulation to impact against, the impact causing protruding fibers from the pieces of insulation to entangle and lock together. It is not necessary to coat all the walls of the cavity with the pressure sensitive adhesive—coating only a majority of the area of the largest area wall of the cavity is sufficient, but two or more of the walls of the cavity can be provided with a continuous or discontinuous coating of the pressure sensitive adhesive.

The method produces a just installed insulation product formed in place by spraying either dry clumps, nodules, and/or pils of inorganic fiber or the same containing a low percentage of water with or without a water soluble binder therein. The majority of the nodules typically have a maximum dimension of one-half inch. The clumps or nodules are mostly smaller than one-half inch in diameter, but larger sizes can be used. Nodules are defined as very small diameter of fibrous insulation of 0.25 inch diameter and smaller. Clumps are defined as having diameters greater than the diameter of nodules and up to the conventional size of clumps in the blowing insulation industry that are typically less than about 0.5 inch in diameter. Piliform, pils, are defined as having a diameter of less than about 0.15 inch in diameter. The clumps and/or nodules and/or pils are produced by running fibers as described above, typically virgin glass fiber insulation and/or fiber glass insulation containing a cured binder through a hammer mill, slicer-dicer or other device for reducing material to small clumps and/or nodules and/or pils using methods common in the industry. The smaller the holes in the plate(s) in the exit portion of the hammer mill, the smaller the pieces of fibrous insulation exiting the hammer mill.

The method of the invention produces just-installed fibrous insulation having a lower moisture content than other conventional spray-in fibrous insulation methods. The just-installed insulation of the present invention typically has a moisture content of less than about 30 percent, based on the dry weight of the just-installed insulation, more typically less than about 20 percent, and most typically less than about 10 percent, even less than about 5 percent. The clumps and/or nodules and/or pils of fibrous insulation being sprayed-in in the invention can be substantially dry, or can be coated with a small amount of water, with or without a water soluble binder or other type of binder to enhance the insulation pieces adhering together when impacted on each other to resist slumping and collapse during and after installation, but in most cases the present invention permits using substantially dry insulation.

The glass fiber product formed by the method of the invention has unique characteristics including:
a) Inorganic fiber small diameters having low moisture content and sorption potential to facilitate drying time and to minimize mold growth potential and to produce high thermal performance at low densities to permit a variety of R-values in standard wall cavity depths while meeting existing and newly proposed building code requirements, and finally, producing shorter drying times than prior art wet sprayed-in insulation requires.
b) The just-installed insulation can be comprised of clumps, nodules and/or pils that permit a variety of commercial blowing machines, including those specifically designed for blowing cellulose insulation, to produce a uniform cavity fill, high quality surface appearance, fast rate of application, good wetting characteristics, minimal plugging potential and high thermal and acoustical performance. Exemplary, at least about 70 percent of the clumps, nodules and pils are smaller than one-half inch, more typically at least about 80 percent and even more typically at least about 90 percent. Most preferably the majority of the nodules are smaller than one-quarter inch, or even smaller than 0.15 inch, and the smaller the nodules the better with at least about 70 percent being smaller than one-quarter inch, at least about 80 percent and at least about 90 percent being even better.

When a binder is used on the pieces of insulation, the binder is typically a water soluble partially hydrolyzed polyester oligomer, but other liquidous binders including those known in the art for this purpose and water soluble resins, polymers and oligomers providing sufficient tackiness, to cause the nodules to stick to the cavity surfaces and to each other such that the installed insulation does not collapse or slump, are suitable. The binder resin or polymer should produce sufficient initial tackiness to permit vertical wall cavities of various depths to be filled by spraying without settling, slumping or collapsing. When a binder is sprayed on or mixed with the clumps, etc., the binder is typically present in an amount in the range of about 1 wt. percent to about 6 wt. percent (dry solids basis of the installed insulation product) and preferably the amount of water present in the just installed product is in the range of about 30 wt. percent to about 0 wt. percent, based on the dry weight of the just-installed fibrous insulation.

Importantly, the low moisture content means that the just-installed fibrous insulation product of the invention will have R values as high as about 15 while containing only about 1.5 lbs. or less of water in a standard building wall cavity, i.e. 8 feet by 14.5 inches by 3.5 inches. A standard wall cavity is formed by vertical commercially available standard 2×4s, 8 feet high and 16 inches on center. Hereafter the term “standard cavity” will be used to describe this size cavity.

Normally, the inorganic fibers are glass fibers, but other fibers including slag wool, mineral wool, rock wool, ceramic fibers and carbon fibers are included in the term inorganic fibers. Any kind of stable glass fibers are suitable but preferably the glass fibers contain at least about 8% B₂O₃ as an infrared blocker to enhance thermal performance at low installed densities. Other infrared radiation blocking constituents (reflecting, scattering and/or absorbing) can also be included in the glass chemistry or can be applied to the glass fiber as surface coatings, mixed with the fibers or in the adhesive mix to enhance thermal performance.

The step of coating at least one wall of the cavity with a pressure sensitive adhesive can be accomplished by brushing, rolling, spraying or other conventional manner of coating a wall, spraying being most typical because of the ease and speed of using spraying. The nozzle for spraying on the pressure sensitive adhesive can be part of a system separate from the blowing system used to spray-in the fibrous insulation, or it can be mounted on or in a nozzle used in the insulation blowing system, typically with a separate valve and valve activator for starting and stopping the spray of pressure sensitive adhesive.

Glass fiber insulation pieces, when sprayed into a cavity to form the just-installed insulation product of the invention, form a uniform thermal/acoustical insulation mass in a wall cavity having a density typically of 3 lbs./cu. ft. (PCF) or less, more typically of 2 PCF or less and can even be 1 PCF or less. The density will depend to some extent upon the R value desired. For a standard cavity the product of the invention will have an exemplary installed insulation in a standard cavity, when dry, will have a density within the range of about 0.8 to about 1 PCF and an R value of about 13, or a density in the range of about 1.5 to about 1.8 PCF and an R value of about 15. This low density and a low moisture content results in a superior insulation product having low cost and a substantially faster drying time than previous wet blown-in wall cavity insulation.

The invention is also applicable to cellulosic fibers. Cellulose loose fill insulation is also sprayed into wall cavities, but to make the insulation stay in the cavity and not fall out, it is necessary to penetrate it with water such that as much as 10 pounds or more of water exists in the insulation as installed in a standard eight foot high wall cavity formed by the standard construction of 8 foot, 2″×4″ inch studs on 16 inch centers. Such an installation takes days to dry sufficiently to install wallboard. It is known to add a powder adhesive to the cellulose insulation prior to injecting water into the blow to reduce the amount of water needed to get the cellulose to stick to the wall of the cavity as disclosed in U.S. Pat. No. 4,773,960, but the just installed insulation still contains much more than 15 percent water. By pre-spraying at least a major area of the largest area wall of a cavity with a liquidous pressure sensitive adhesive, the moisture content of the spray-on cellulose can be reduced to at least 15 percent or less.

The liquidous pressure sensitive mixture for spraying on the cavities prior to blowing, or otherwise applying clumps or nodules of insulation onto the tacky surfaces, can also contain one or more other functional additives such as fungicides, biocides, pesticides, microsphere insulation, encapsulated short chain waxes, calcium chloride salts or other phase change material that acts as a heat transfer blocker or heat storage or absorbing medium, radiation blocking or reflecting material, etc.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### DETAILED DESCRIPTION

It is well known how to make loose-fill clumps of inorganic fibers for forming blown-in insulation. The inorganic fiber used in the present invention can be glass fibers, mineral wool, slag wool, or a ceramic fiber and preferably is fiberglass, most preferably containing in the glass a boron oxide content of at least about 8 percent. Typically the inorganic fiber has a mean or average fiber diameter less than or equal to about 5 microns, more typically less than about 3 microns such as an average fiber diameter of 2.5 microns or less, even more typically equal to or about 2 microns or equal to or less than about 1.5 microns and even a mean diameter being about 1 micron, to produces an insulation product having high thermal performance at low installed densities. The lower the mean fiber diameter, the more efficient the thermal insulation per pound.

Clumps are defined above as very small bundles of insulation fibers that are equal to or less than about ½ inch in length, width and thickness or diameter. The size of at least the majority of the nodules in at least two of three dimensions, or diameter, is about ¼ inch or less. Pils are defined as pieces in which the body of the piece, not counting some projecting fibers, has a diameter of about 0.15 inch or less. Oversize clumps are defined as having a physical size greater than that of these clumps of fiber. Most conventional mineral fiber loose-fill insulation products designed for attic application consist of oversize clumps of fibrous material. These types of products will not provide the desired uniformity and quality surface appearance required for spray-applied application to meet stringent inspection standards and to ensure consistent thermal performance. In addition, if these products were used for spray applied application, they would be more prone to plugging, not allow for adequate wetting when binder is applied and would not provide required R-value at cost competitive installed densities.

Fibrous loose-fill insulation is subject to all three modes of heat transfer—radiation, conduction and convection. Convection can be minimized by reducing size of the nodules of loose insulation and preferably by producing more consistently sized nodules to limit potential air passages (voids) that can occur within the installed material. Convection is also minimized with a uniform cavity fill with no gaps or voids caused by bridging of the clumps, and with a fill that is such that the insulation is even with the framing faces when installation is complete. Insulation containing clumps, nodules or pil size also makes this possible. If convection is kept to a minimum, infrared thermal radiation and conduction are the remaining modes of heat transfer that need to be reduced to ensure best thermal performance, i.e., high thermal resistance (R-value). Some studies have shown that if convection is minimized, infrared radiation can account for about 30 to 40% of the heat flow through a fibrous insulation product. The remaining portion of the heat flow would then be due to still air and solid material conduction.

From a physics standpoint, a fibrous insulation product with fine fiber has more surface area per mass of fiber material to intercept and scatter infrared thermal radiation versus a product with coarser fiber diameter. This is especially effective if the chemistry of the fiber enhances the scattering and absorption of the radiation. For glass fibers, having 8% or higher concentrations of B₂O₃ in the glass chemistry greatly enhances the scattering and absorption of infrared thermal radiation. Surface coatings can also be applied to fibers to enhance scattering and absorption. A network of fine fiber is also more effective in creating pockets of still air and minimizing sold conduction through the individual fibers. The combination of improved radiation scattering, minimal air movement and minimized sold conduction produces very good thermal performance. An additional benefit of fine fiber is that the material can be installed at low densities to achieve standard R-value requirements, e.g., R-13 @ 0.8 to 1.0 PCF installed density or R-15 @1.5 to 1.8 PCF in a standard 2×4, 8′ high, 16″ on centercavity.

Cellulose products require installed densities ranging from 2 to 3 PCF to achieve an R-13 level in thermal insulation in a standard wall cavity. These products cannot achieve an R-15 level due to density limitations and thermal limitations of the cellulose material. Most existing loose-fill mineral fiber products require installed densities of at least about 1.2 to 1.5 PCF to achieve an R-13 level of insulation and densities ranging from about 1.8 to 2.5 PCF to achieve an R-15 level in a standard 2×4 cavity. It is known to add a powder adhesive to the cellulose insulation prior to injecting water into the blow to reduce the amount of water needed to get the cellulose to stick to the wall of the cavity as disclosed in U.S. Pat. No. 4,773,960, but the just-installed insulation still contains much more than 15 percent water. By pre-spraying at least the largest wall of a cavity with a pressure sensitive adhesive, the moisture content of the spray-on cellulose can be reduced to at least 15 wt. percent or less. Although a relatively high density is required for cellulose application, the cellulose material is often lower in material cost than most inorganic fiber products in similar applications and at similar R-values levels. Therefore, a need exists for a low density, cost competitive inorganic fiber product to use instead of cellulose. The invention provides this capability

The pieces of inorganic fibrous insulation for use in the present invention are made with conventional hammer mills, slicer-dicers or equivalent material processing machines. A slicer-dicer cuts or shears blankets, a layer, of fiberglass insulation into small cube-like or other three dimensional pieces. Hammer mills and the like tear and shear virgin fiber glass or fiber glass blanket and tend to roll them into generally irregular spherical or rounded nodules, keeping most pieces in the mill until they achieve a pre-selected size. The piece size is controlled using an exit screen containing the appropriate opening size to produce the desired nodule size. Any type of fiberglass insulation product can be processed in a hammermill, i.e. e. blanket in which the glass fibers are bonded together with a cured resin, usually a thermoset resin, or a blanket of virgin fiberglass containing only de-dusting oil, silicone anti-stat, etc. Also, the binder used to bond the glass fibers together in the blanket can also contain one or more of functional ingredients such as IR barrier agents, anti-static agents, anti-fungal agents, biocides, de-dusting agents, pigments colorants, etc., or one or more of these functional ingredients can be applied to the fibers either before or during processing in the hammer mill or other reducing device.

The size of openings in an exit screen in the hammer mill or similar device are varied to produce the desired nodule size. The preferred size depends on the cutting and shearing characteristics of the fibrous material. For fiberglass material, an exit screen size with square openings ranging from 1 to 3 inches can be used to produce nodule or clump sizes that range in size from ⅛ inch to ¾ inch.

The pieces of inorganic fiber insulation, such as fiberglass, can also be made from what is called “virgin blowing wool”. Virgin blowing wool is made by making glass fiber insulation in a conventional manner except that no resin is applied to the fibers. Instead, only a de-dusting oil and/or an anti-stat like silicone is applied to the fibers and the resultant fibrous blanket is then run through the hammer mill or similar processing device. Other agents can also be applied to the fibers such as a fungicide, a biocide, filler particles and/or IR retarding additives, either immediately after fiberizing or in the hammer mill. The inorganic fibers used in the present invention can be glass, mineral wool, slag wool, or a ceramic fiber and preferably is fiberglass. Inorganic fibrous material has low moisture sorption (absorption and adsorption) potential, typically less the 5% moisture gain by wt. The application of fiber surface waterproofing agents, such as silicone or de-dusting oils can further reduce moisture sorption potential. A material with low moisture sorption is preferred for spray applied application to allow for fast drying and to limit moisture storage capacity, which greatly limits the potential for mold growth.

Prior to spraying in dry, or water or aqueous binder coated, fibrous insulation pieces into the cavity(s), at least a wall of each cavity having the largest area, and more typically also at least a portion of two or more other walls of the cavity are coated with a liquidous pressure sensitive adhesive. This is accomplished by spraying, painting or rolling the liquidous adhesive onto the wall or walls, most usually by spraying. The pressure sensitive adhesive used in the invention is typically in aqueous solution, suspension or emulsion, but hydrocarbon solvents or matrix can also be used in addition to or instead of water, to form the liquidous pressure sensitive adhesive mixture. Any coating or pressure sensitive type adhesive can be used that leaves a tacky surface on the structural member, a tacky surface that will cause the pieces of fibrous insulation to adhere to the wall or walls of the cavity. Acrylic resins and styrene-butadiene-rubber, having a glass transition temperature typically below about 15 degrees Celsius, more typically less than about 0 degrees with those being less than about minus 20 degrees are exemplary. The liquidous pressure sensitive adhesive can also contain one or more of functional ingredients such as IR barrier agents, anti-static agents, anti-fungal agents, biocides, pigments colorants, etc.

Some examples of suitable pressure sensitive adhesives useful in the present invention include an adhesive called BASF Acronal A200 (−46 C T_{g}) or BASF A378_(−46 C T_{g}) available from BASF. Typical concentrations of aqueous liquidous pressure sensitive adhesive mixtures are within the range of about 10 percent to about 60 percent solids. The small amount of liquid carrier in the coating on the structural member, water, hydrocarbon solvent, or mixtures thereof, will evaporate and be absorbed by the structural member quickly to form the desired tacky surface. Most any type of spray equipment can be used to apply the coating. One device is airless spray equipment using a single 0.015 to 0.020″ spray tip that delivers about a 4″ fan. The pressure sensitive coating is applied a rate that is sufficient for the surface to quickly develop tack as it dries and continue to be tacky after it's completely dry. Coverage rates will also depend on the solids content. For a 15% solids adhesive, the rate is typically less than 2000 sq. ft. per gallon and up to about 400 sq. ft. per gallon. Desirably, the minimum amount of coating is applied that provides the desired level of tack. It is important to understand that application of the water based tacky coatings adds a small amount of moisture to each cavity in the range from 0.1 lb to 0.5 lb per typical cavity. However, due to the high surface area of the cavity this moisture typically dries quickly.

An adjustable rate pump connected to a use tank can supply the liquidous pressure sensitive adhesive at the desired rate and pressure to one or more jet spray tips, roller or brushes, or the roller and brush can be used in a conventional dip and use manner. The one or more jet spray tips can be mounted on one or more flexible hoses coming from the pump, or the one or more tips connected to one or more hoses can alternatively be mounted on a spray insulation nozzle, to properly coat the wall(s) prior to spraying in the fibrous insulation.

When using a binder coating on the insulation pieces, prior to pouring fibrous insulation into any conventional blowing machine, an aqueous binder solution is made up by adding the proper amount of water to a tank and then adding the proper amount of a binder, preferably in the form of a concentrated solution of the binder, to the water in the tank while optionally stirring to insure proper mixing. If a powdered material is used, more time and stirring will be required to obtain the solution. Also, particularly when the water in the tank is cool, it may be advantageous to heat the water to at least room temperature before adding the powdered binder. Numerous water-soluble resins can be used in the present invention, but the preferred binder is a water soluble partially hydrolyzed polyester oligomer. The most preferred binder is a partially hydrolyzed polyester oligomer such as S-14063 and SA-3915 available from Sovereign Specialty Chemicals of Greenville, S.C. The S-14063 resin, containing 23-36% solids, is diluted to a lower concentration when added to the water in the mixing tank, preferably at a 1:1 ratio with water, but water to S-14063 ratios ranging from about 0.5:1 to about 2:1 will also provide the necessary tackiness to hold the insulation in place. The SA-3915 adhesive contains 10% to 15% solids and is normally used without further dilution. Other resins that are water soluble include polyvinyl acetate, polyvinyl pyrilidone, and polyvinyl alcohol.

Insulation blowing machines have an outlet through which the pieces of insulation are ejected as a rapidly moving air suspension. One end of a hose is connected to the outlet. The other end of the hose can be in the location that the operator will need for installing the insulation. The blowing machine hose can be up to about 200 feet long and typically have a diameter of about 2.5 inches to about 4 inches depending upon the type of blowing machine and the intended use or particular application. The blowing machine mixes the pieces of insulation with air and blows the resulting air suspension out the outlet and through the hose. A nozzle is normally attached to the end of the hose, the nozzle usually having one or more handles for the operator to hold to aim the nozzle in the proper direction and orientation for spraying the cavities. The nozzle will typically have one or more jet spray tips for spraying the aqueous binder solution onto the fibrous insulation near the exit end of the nozzle, or if dry insulation is being blown into the cavities, the one or more jets can be used to spray the pressure sensitive adhesive mixture onto the wall(s) of the cavities before spraying the insulation into the cavities.

When water or an aqueous binder is applied to the pieces of fibrous insulation, adjustable rate pump connected to a use tank supplies the aqueous binder solution at the proper rate and pressure to the jet spray tips through one or more flexible hoses to properly coat the nodules with the desired amount of resin solution. One or more jet spray tips can be used to apply the aqueous binder solution to the nodules at an elevated solution pressure supplied by the pump. Usually two or three spray tips are used opposite each other across the moving column of suspended clumps and/or nodules. Many different types of jet spray tips can be used and one that performs well is Spray Systems Company's 25 degree flat spray Unijet® tip. Another jet spray tip that is suitable is Spray Systems Company's 65 degree Unijet® tip.

The resultant aqueous binder solution coated pieces of inorganic fiber insulation contain, in an outer region of the pieces, a moisture content of less than about 30 wt. percent, based on the dry weight of the clumps and/or nodules, typically much less such as less than than about 20 percent, more typically less than about 10 wt. percent and can be down to as low as less than 5 percent or even about 0 percent. At these weight percentages, the amount of initial water content in a standard cavity would range from about 1.5 lbs to about 0.13 lbs. or less for an R13 application for installed density ranging from about 0.8 to about 1.0 PCF. The resultant coated pieces of inorganic fiber insulation contain an addition of binder solids of up to about 6 wt. percent, based on the dry weight of the nodules, typically up to about 3 wt. percent and most typically from about 0 to about 2 wt. percent for installed densities ranging from 0.8 to 1.0 PCF.

### EXAMPLE 1

At least three walls of standard wall cavities were first sprayed with a liquidous pressure sensitive adhesive containing BASF Acronal A200 at 50% solids content, pH of about 7, viscosity of about 75 cps and an airless spray application rate of 800 sf/gallon and allowed to set for about 60 minutes before spraying fibrous insulation into the cavities. Using a Unisul Volumatic® III blowing machine equipped with 150 feet of 4 inch diameter hose, an insulation mass flow rate of approximately 18 lbs/minute was achieved using a loose-fill fiber glass insulation product made with minus one-quarter inch nodules comprised of 2.0 micron average diameter glass fiber having an 8.7% B₂O₃ content in the glass and a ¼ inch average diameter nodule size. Glass fibers had on their surface silicone/anti-stat (0.05 wt. %) and a de-dusting oil (0.06 wt. %), based on the weight of the glass fibers. The blowing machine was operated with the transmission in 3rd gear, with 100% of the available blower air delivered to the rotary airlock assembly and with the slide gate (feed gate) set at 12 inches. The blower and secondary gearbox speeds (RPM settings) on the blowing machine were set to the manufacturer's recommended settings of 1425 and 1050 rpm, respectively.

The mass flow of insulation was allowed to freely flow through the blowing hose into a nozzle at the end of the working hose. The nozzle was also used to apply Sovereign Chemical 's S-14063 acrylic resin solution having about 24 percent solids further diluted 1:1 with water to the mass flow of insulation as it exited from the working nozzle. The resin solution was applied at a rate of about 0.5 gallons/minute with the use of a Spray Tech pump (model 0295003). The spray nozzle assembly consisted of a 4 inch diameter tube the end of which was surrounded by an annular manifold containing two Spray System Co. model TPU-65-015 spray tips screwed into threaded ports located 180 degrees apart on the manifold. The ports were set at a 30 degree angle to the centerline of the mass insulation flow direction. This allowed the binder mix, binder solution plus water, to be sprayed and entrained into the insulation mass flow without disrupting the flow characteristics of the insulation material to provide an adhesive mix ratio in the just installed product of 0.24-0.26 or a resin content in the oven dried insulation sample of about 2-4 wt. percent.

By moving the nozzle from bottom to top and with a side to side motion from the bottom of the cavity to the top, the installer sprayed the wetted mass flow of insulation into various 8 foot high cavities defined between 8 foot high vertical 2×4's spaced on 16 inch centers or 24 inch centers to achieve a consistent fill with about 1-2 inches of excess material extending beyond faces of each vertical framing member. Standard SPF wood framing (2×4 or 2×6) was used to form the cavities of the test walls. Oriented Strand Board (OSB) sheathing was used as the back wall of each cavity.

The installer held the spray nozzle approximately 6 feet away from the open cavity faces during the installation process. Shortly after installation, the excess material was removed with the use of a commercial rotary wall scrubber (Krendl™ model 349B). The removed excess material was vacuumed up using a 50 foot length of 4 inch diameter hose connected to a centrifugal vacuum fan (Wm. W. Meyer & Sons, Inc. Versa-Vac(11).

Using the described equipment set up, the just installed moisture content of the just installed insulation in each test wall was measured to be about 20-30 wt. percent. Measurement was accomplished with the use of a load cell connected to a chain hoist. A large oven was used to dry the samples after the initial weights were taken. Over the about 20 to about 30% range, approximately 0.5 to about 0.7 lbs of water existed in a standard 8 foot high, 16 inch on center 2×4 wall cavity. The oven dry density of the installed material was found to range from about 0.8 to about 1.9 PCF, depending upon the distance of the nozzle from the cavity with the lowest density achieved at a distance of about 6 feet. Thermal testing on various samples in this same density range showed that the material would provide an R-13 level of insulation in a standard 2×4 cavity. Loss On Ignition (LOI) testing indicated that approximately 2 to about 3 percent binder solids existed in the installed material. With this content of binder solids, no problems were encountered with any installed material falling out of the wall cavities or with any post-installation settling or fallout. This was the case for both 2×4 and 2×6 cavities. Because of the low moisture content in the just-installed insulation, a drying time of only about 12-24 hours was required before wall board or other facing could be installed without any danger of mold forming in the insulation.

In addition to the equipment set up previously described, numerous other combinations of pump flow rates, adhesive to water ratios, spray nozzle configurations, blowing machine settings, blowing machine types, adhesives and installation techniques can be used to achieve similar installed densities and moisture levels.

### EXAMPLE 2

The same set up used in Example 1 was used except no water or binder was sprayed on the pieces of glass fiber insulation. The glass fiber insulation was the same as used in Example 1 but was substantially dry having an adsorbed moisture content of less than about 5 wt. percent as it entered the cavities. The dry pieces of insulation, having a size of about ¼ inch and smaller, adhered readily to the pressure sensitive adhesive coated walls of the cavity and filled the cavities with acceptable just-installed insulation integrity and strength and acceptable rebound percentage, i.e. wt. percentage of pieces of insulation that bounced off or fell onto the floor below the cavities. The resultant just-installed insulation had a moisture content of less than about 5 wt. percent and because of this low moisture content, wall board or other facing could be installed immediately without any danger of mold formation or growth due to the moisture content of the insulation in the wall cavities. The predominant amount of the oven dried moisture content of this just-installed insulation comes from the adsorbed moisture of the fiber glass insulation that was present prior to its use. The main difference between this example and Example 1 is the lower amount of moisture and resin in the just installed product, and therefore lower cost and elimination of drying time for the just-installed insulation. In Example 2, the tacky cavity surfaces hold the insulation in the cavity and the velcro like surfaces of the small insulation nodules packed against each other hold the dry applied insulation in place. Surprisingly, the formed in-place blanket insulation stays in the cavity, it does not slump and even the outer surface stays intact.

The low moisture of the installed products greatly limits mold growth potential. By adding fungicide, biocide or desiccant agents to the fibers or fibrous insulation pieces, during manufacture such as, but not limited to, benzimidazole 2-(4-thiazolyl), available as Iraguard™ F3000 from Ciba Specialty Chemicals, Inc., mold growth potential can be further limited. A material with all of these attributes will be superior to any existing material in current use in spray applied insulation systems. These and other functional ingredients can be applied in the aqueous binder when used, and always in the liquidous pressure sensitive adhesive sprayed on the wall or walls of the cavities.

An unexpected result of the present invention is the low moisture content of the just-installed insulation that is achievable when one or more walls of he cavities are coated with a liquidous pressure sensitive adhesive prior to spraying the pieces of fibrous insulation into the cavities. Also, as confirmed in prior patents, it has been found in the past that excess adhesive was required to coat clumps of fiberglass containing a silicone on the surfaces of the fibers, but a further unexpected result of the present invention is that the clumps and/or nodules of insulation can contain silicone which is desirable for the waterproofing function that the silicone conventionally produces. With some or all of the unique attributes of the invention, a uniform cavity fill can be obtained over a wide range of installed R-values at low installed densities, having low moisture contents for fast drying. Mold growth potential is minimized and by keeping the installed moisture and density low, and the material cost is also kept to a minimum using the invention.

The liquidous pressure sensitive adhesive mixtures used in the invention can contain conventional amounts of one or more biocides, pesticides, fungicides, anti-static agents, hydrophobic agents such as a silicone, fire retardants and IR reflectors including calcium carbonate particles. The pieces, clumps, nodules and/or pils of inorganic fibrous insulation can also contain conventional amounts of one or more biocides, anti-static agents, de-dusting oils, hydrophobic agents such as a silicone, fire retardants and IR reflectors including calcium carbonate particles. Fine particles of limestone or other calcium carbonate material can be included in the cured binder holding the fibers in the clumps or nodules together. The other additives, when present, are also preferably included with the clumps or nodules.

Several examples and ranges of parameters of exemplary embodiments of the present invention have been described above, but it will be apparent to those of ordinary skill in the insulation field that many other embodiments by manipulation of the parameters are possible and those are included in the following claimed invention. For example, although only a few different resin binders and pressure sensitive adhesives are specifically disclosed, there are many other pressure sensitive adhesives and insulation binders that will function in the above disclosed invention to produce the useful result of having high tack value on the walls of the cavities and on the pieces of fibrous insulation. While most of the above discussion involves using the present invention in generally vertical wall cavities, this insulation product can be used to insulate attics or any area that can be reached with an array of the air suspended product.

1. A method of producing just-installed thermal insulation in a cavity of a structure, the just-installed insulation having a moisture content of less than about 30 weight percent, based on the dry weight of the just-installed insulation, the method comprising;
a) applying a coating comprising a liquidous pressure sensitive adhesive on at least a wall of the cavity having the largest area and allowing the coating to dry sufficiently to form a tacky surface,
b) feeding fibrous insulation in the form of clumps, nodules, pils or any mixtures thereof into a blowing machine whereby the fibrous insulation is suspended in an air stream and blown through a hose connected to the blowing machine,
c) directing the air suspended clumps or nodules or pils or any mixtures thereof into the cavity and onto the coated wall of the cavity to fill the cavity with just-installed insulation, the moisture content of the just-installed insulation being less than about 30 wt. percent.

2. The method of claim 1 wherein the insulation comprises glass fibers.

3. The method of claim 1 wherein the pressure sensitive adhesive has a glass transition temperature of less than about 15 degrees C.

4. The method of claim 2 wherein the pressure sensitive adhesive has a glass transition temperature of less than about 15 degrees C.

5. The method of claim 1 wherein the pressure sensitive adhesive has a glass transition temperature of less than about 0 degrees C.

6. The method of claim 2 wherein the pressure sensitive adhesive has a glass transition temperature of less than about 0 degrees C.

7. The method of claim 1 wherein the pressure sensitive adhesive has a glass transition temperature of less than about minus 10 degrees C.

8. The method of claim 2 wherein the pressure sensitive adhesive has a glass transition temperature of less than about minus 10 degrees C.

9. The method of claim 1 wherein the liquidous pressure sensitive adhesive also contains one or more functional ingredients selected from the group consisting of more biocides, pesticides, fungicides, anti-static agents, hydrophobic agents such as a silicone, fire retardants short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

10. The method of claim 2 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

11. The method of claim 3 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change, and IR reflectors including calcium carbonate particles.

12. The method of claim 4 wherein the liquidous pressure sensitive adhesive mixture also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change.

13. A method of producing just-installed thermal insulation in a cavity of a structure, the just-installed insulation having a moisture content of less than about 15 weight percent, based on the dry weight of the just-installed insulation, the method comprising;
a) applying a coating comprising a liquidous pressure sensitive adhesive on at least a wall of the cavity having the largest area and allowing the coating to dry sufficiently to form a tacky surface,
b) feeding fibrous insulation in the form of clumps, nodules, pils or any mixtures thereof into a blowing machine whereby the fibrous insulation is suspended in an air stream and blown through a hose connected to the blowing machine,
c) directing the air suspended clumps or nodules or pils or any mixtures thereof into the cavity and onto the coated wall of the cavity to fill the cavity with just-installed insulation, the moisture content of the just-installed insulation being less than about 15 wt. percent.

14. The method of claim 13 wherein the insulation comprises glass fibers.

15. The method of claim 15 wherein the pressure sensitive adhesive has a glass transition temperature of less than about 15 degrees C.

16. The method of claim 14 wherein the pressure sensitive adhesive has a glass transition temperature of less than about 15 degrees C.

17. The method of claim 13 wherein the pressure sensitive adhesive has a glass transition temperature of less than about 0 degrees C.

18. The method of claim 14 wherein the pressure sensitive adhesive has a glass transition temperature of less than about 0 degrees C.

19. The method of claim 13 wherein the pressure sensitive adhesive has a glass transition temperature of less than about minus 10 degrees C.

20. The method of claim 14 wherein the pressure sensitive adhesive has a glass transition temperature of less than about minus 10 degrees C.

21. The method of claim 13 wherein the liquidous pressure sensitive adhesive also contains one or more functional ingredients selected from the group consisting of more biocides, pesticides, fungicides, anti-static agents, hydrophobic agents such as a silicone, fire retardants short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

22. The method of claim 14 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

23. The method of claim 15 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change, and IR reflectors including calcium carbonate particles.

24. The method of claim 16 wherein the liquidous pressure sensitive adhesive mixture also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

25. A method of producing just-installed thermal insulation in a cavity of a structure, the just-installed insulation having a moisture content of less than about 5 weight percent, based on the dry weight of the just-installed insulation, the method comprising;
a) applying a coating comprising a liquidous pressure sensitive adhesive on at least a wall of the cavity having the largest area and allowing the coating to dry sufficiently to form a tacky surface,
b) feeding fibrous insulation in the form of clumps, nodules, pils or any mixtures thereof into a blowing machine whereby the fibrous insulation is suspended in an air stream and blown through a hose connected to the blowing machine,
c) directing the air suspended clumps or nodules or pils or any mixtures thereof into the cavity and onto the coated wall of the cavity to fill the cavity with just-installed insulation, the moisture content of the just-installed insulation being less than about 5 wt. percent.

26. The method of claim 25 wherein the insulation comprises glass fibers.

27. The method of claim 25 wherein the pressure sensitive adhesive has a glass transition temperature of less than about 15 degrees C.

28. The method of claim 26 wherein the pressure sensitive adhesive has a glass transition temperature of less than about 15 degrees C.

29. The method of claim 25 wherein the pressure sensitive adhesive has a glass transition temperature of less than about 0 degrees C.

30. The method of claim 26 wherein the pressure sensitive adhesive has a glass transition temperature of less than about 0 degrees C.

31. The method of claim 25 wherein the pressure sensitive adhesive has a glass transition temperature of less than about minus 10 degrees C.

32. The method of claim 26 wherein the pressure sensitive adhesive has a glass transition temperature of less than about minus 10 degrees C.

33. The method of claim 25 wherein the liquidous pressure sensitive adhesive also contains one or more functional ingredients selected from the group consisting of more biocides, pesticides, fungicides, anti-static agents, hydrophobic agents such as a silicone, fire retardants short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

34. The method of claim 26 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

35. The method of claim 27 wherein the liquidous pressure sensitive adhesive also contains one or more functional ingredients selected from the group consisting of more biocides, pesticides, fungicides, anti-static agents, hydrophobic agents such as a silicone, fire retardants, short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change, and IR reflectors including calcium carbonate particles.

36. The method of claim 28 wherein the liquidous pressure sensitive adhesive mixture also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

37. Just installed fibrous insulation in a cavity in a structure, the insulation comprising clumps or nodules or pils or any mixtures thereof having a just-installed moisture content of less than about 30 wt. percent, based on the dry weight of the installed insulation, and having on at least a portion of at least a surface adjacent a wall of the cavity a layer of a pressure sensitive adhesive having a glass transition temperature of less than about 15 degrees C.

38. The insulation of claim 37 wherein the glass transition temperature is less than about 0 degrees C.

39. The insulation of claim 37 wherein the glass transition temperature is less than about minus 10 degrees C.

40. The insulation of claim 37 wherein the fibrous insulation comprises glass fibers.

41. The insulation of claim 38 wherein the fibrous insulation comprises glass fibers.

42. The insulation of claim 39 wherein the fibrous insulation comprises glass fibers.

43. The insulation of claim 37 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

44. The insulation of claim 38 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

45. The insulation of claim 39 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

46. The insulation of claim 40 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

47. Just installed fibrous insulation in a cavity in a structure, the insulation comprising clumps or nodules or pils or any mixtures thereof having a just-installed moisture content of less than about 15 wt. percent, based on the dry weight of the installed insulation, and having on at least a portion of at least a surface adjacent a wall of the cavity a layer of a pressure sensitive adhesive having a glass transition temperature of less than about 15 degrees C.

48. The insulation of claim 47 wherein the glass transition temperature is less than about 0 degrees C.

49. The insulation of claim 47 wherein the glass transition temperature is less than about minus 10 degrees C.

50. The insulation of claim 47 wherein the fibrous insulation comprises glass fibers.

51. The insulation of claim 48 wherein the fibrous insulation comprises glass fibers.

52. The insulation of claim 49 wherein the fibrous insulation comprises glass fibers.

53. The insulation of claim 47 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

54. The insulation of claim 48 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

55. The insulation of claim 49 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

56. The insulation of claim 50 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

57. Just installed fibrous insulation in a cavity in a structure, the insulation comprising clumps or nodules or pils or any mixtures thereof having a just-installed moisture content of less than about 5 wt. percent, based on the dry weight of the installed insulation, and having on at least a portion of at least a surface adjacent a wall of the cavity a layer of a pressure sensitive adhesive having a glass transition temperature of less than about 15 degrees C.

58. The insulation of claim 57 wherein the glass transition temperature is less than about 0 degrees C.

59. The insulation of claim 57 wherein the glass transition temperature is less than about minus 10 degrees C.

60. The insulation of claim 57 wherein the fibrous insulation comprises glass fibers.

61. The insulation of claim 58 wherein the fibrous insulation comprises glass fibers.

62. The insulation of claim 59 wherein the fibrous insulation comprises glass fibers.

63. The insulation of claim 57 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

64. The insulation of claim 58 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

65. The insulation of claim 59 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.

66. The insulation of claim 60 wherein the layer of pressure sensitive adhesive also contains one or more functional ingredients selected from the group consisting of one or more biocides, pesticides, fungicides, anti-static agents, hydrophobic agents such as a silicone, fire retardants and IR reflectors including calcium carbonate particles, encapsulated phase change material such as short chain waxes including pariffin, low melting polyvinyl chlorides, sodium sulfate decahydrate, calcium chloride hydrates, and other materials that undergo a phase change between about 0 and 110 degrees F. that either absorbs heat or gives off heat energy during the phase change and IR reflectors including calcium carbonate particles.
